(19) United States
(12) Patent Application Publication
(10) Pub. No.: US 2026/0309067 A1
(43) Pub. Date: Oct. 8, 2026

(54) EXHAUST HEAT RECOVERY DEVICE

(71) Applicant: MARELLI CORPORATION, Saitama (JP)

(72) Inventors: Takaharu YAMAMOTO, Saitama (JP); Tooru HISANAGA, Saitama (JP); Naoharu CHIBA, Saitama (JP)

(21) Appl. No.: 19/484,746

(22) PCT Filed: Apr. 26, 2024
(86) PCT No.: PCT/JP2024/016406

§ 371 Date: Dec. 18, 2025

(30) Foreign Application Priority Data
May 18, 2023 (JP) 2023-082327

(51) Int. Cl. F01N 5/02; F01N 13/16; F28D 21/00

(52) U.S. Cl. CPC F01N 5/02; F01N 3/0205; F01N 13/16; F28D 21/0003; F01N 2240/02; F01N 2240/36

(57) ABSTRACT

An exhaust heat recovery device, containing a first exhaust pipe; a second exhaust pipe forming a gap between the second exhaust pipe and the first exhaust pipe; a third exhaust pipe surrounding the second exhaust pipe; a heat recovery material that is provided between the second exhaust pipe and the third exhaust pipe, that performs heat exchange with a medium flow path provided on an outer periphery of the third exhaust pipe; a valve that opens and closes the second exhaust pipe; and a bearing member provided between the second exhaust pipe and the third exhaust pipe; where when the valve is closed, the exhaust gas passes through a gap and is guided to the heat recovery material, and when the valve is open, the exhaust gas bypasses the heat recovery material and is guided to the third exhaust pipe.

### TECHNICAL FIELD

The present invention relates to an exhaust heat recovery device.

### CONVENTIONAL TECHNOLOGY

WO2021/171670A1 discloses a heat exchanger for recovering exhaust heat from exhaust gas, containing: a first outer tubular member fitted onto a surface of an outer circumferential wall of a columnar honeycomb structure; an inner tubular member fitted onto a surface of an inner wall of the columnar honeycomb structure; an upstream tubular member having portions arranged at intervals so as to form a flow path for a first fluid on the inside of the inner tubular member on the inside in the radial direction; a tubular connecting member connecting an upstream end part of the first outer tubular member and the upstream side of the upstream tubular member; a downstream tubular member having portions arranged at intervals so as to form a flow path for the first fluid on the inside of the inner tubular member in the radial direction; and a valve mechanism having an opening and closing valve provided on the downstream end part of the inner tubular member.

### SUMMARY OF THE INVENTION

However, in the heat exchanger described in WO2021/171670A1, the shaft of the opening and closing valve passes through the inner tubular member and is supported on the outside of the downstream tubular member. Therefore, a clearance is required between the shaft of the opening and closing valve and the inner tubular member to allow for rotation of the shaft. As a result, even when the opening and closing valve is closed, exhaust gas may flow out through the clearance, and the heat of the flowing exhaust gas might not be recovered.

An object of the present invention is to improve the performance of recovering heat from exhaust gas in an exhaust heat recovery device.

A first aspect of the present invention provides an exhaust heat recovery device, containing: a first exhaust pipe; a second exhaust pipe into which a downstream end part of the first exhaust pipe is inserted, forming a gap between the second exhaust pipe and an outer periphery of the first exhaust pipe, through which exhaust gas can flow; a third exhaust pipe provided so as to surround the downstream end part of the first exhaust pipe and the second exhaust pipe; an annular heat recovery material that is provided between the second exhaust pipe and the third exhaust pipe, through which the exhaust gas passes inside, and that performs heat exchange with a medium flow path provided on an outer periphery of the third exhaust pipe; a valve that opens and closes the second exhaust pipe, located downstream of the portion of the second exhaust pipe into which the first exhaust pipe is inserted; and a bearing member for the valve provided between the second exhaust pipe and the third exhaust pipe; wherein when the valve is closed, the exhaust gas passes through the gap and is guided to the heat recovery material, and when the valve is open, the exhaust gas bypasses the heat recovery material and is guided to the third exhaust pipe; and the bearing member connects to and retains the second exhaust pipe and the third exhaust pipe, and seals between the rotary shaft of the valve and the second exhaust pipe.

In the above aspect, the bearing member provided between the second exhaust pipe and the third exhaust pipe connects and retains the second exhaust pipe to the third exhaust pipe, and seals the gap between the rotary shaft of the valve and the second exhaust pipe. Therefore, when the valve is closed, exhaust gas can be prevented from flowing out from between the rotary shaft of the valve and the second exhaust pipe. Therefore, the heat recovery performance from the exhaust gas in the exhaust heat recovery device can be improved.

### BRIEF DESCRIPTION OF THE DRAWINGS

FIG. 1 is a perspective view of an exhaust heat recovery device according to an embodiment of the present invention;

FIG. 2 is a cross-sectional view along line II-II in FIG. 1;

FIG. 3A is a left-side view of the vicinity of the valve in FIG. 2, depicting the valve in an open state;

FIG. 3B is a right-side view of the vicinity of the valve in FIG. 2, depicting the valve in an open state;

FIG. 4A is a left-side view of the vicinity of the valve in FIG. 2, depicting the valve in a closed state;

FIG. 4B is a right-side view of the vicinity of the valve in FIG. 2, depicting the valve in a closed state;

FIG. 5 is a cross-sectional view of the exhaust heat recovery device depicting the flow of exhaust gas when the valve is in an open state; and

FIG. 6 is a cross-sectional view of the exhaust heat recovery device depicting the flow of exhaust gas when the valve is in a closed state.

### DETAILED DESCRIPTION OF THE INVENTION

An exhaust heat recovery device 10 according to an embodiment of the present invention is described below with reference to the drawings.

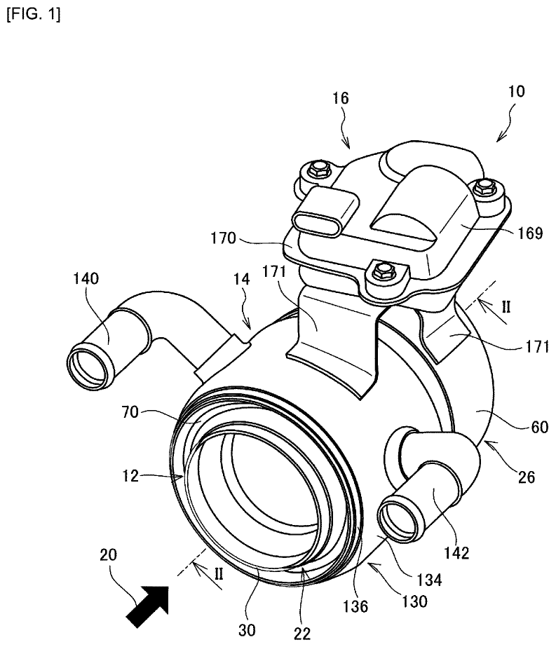

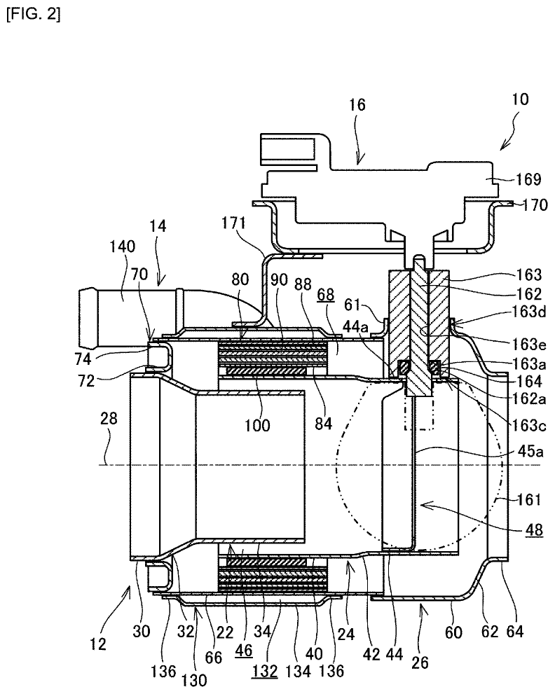

First, the overall configuration of the exhaust heat recovery device 10 will be described with reference to FIG. 1 and FIG. 2. FIG. 1 is a perspective view of an exhaust heat recovery device 10. FIG. 2 is a cross-sectional view along line II-II in FIG. 1.

The exhaust heat recovery device 10 is provided in an exhaust path of an engine (not depicted) of, for example, an automobile (not depicted), and recovers heat from exhaust gas 20 discharged from the engine. The exhaust heat recovery device 10 uses the recovered heat to heat the cooling water of the engine before the engine is warm, for example.

As depicted in FIG. 1, the exhaust heat recovery device 10 includes a gas flow path part 12, a heat recovery part 14, and a switching mechanism part 16.

As depicted in FIG. 2, the gas flow path part 12 includes a first exhaust pipe 22, a second exhaust pipe 24, and a third exhaust pipe 26. Exhaust gas 20 flows through the gas flow path part 12.

Each of the exhaust pipes 22, 24, 26 is formed, for example, from a metal pipe formed in a substantially cylindrical shape. The metal that constitutes each of the exhaust pipes 22, 24, 26 is, for example, stainless steel. The exhaust pipes 22, 24, 26 are arranged coaxially such that the center axes 28 mutually coincide.

The first exhaust pipe 22 allows the exhaust gas 20 to flow from the upstream side to the downstream side. The upper end part of the first exhaust pipe 22 is connected to an exhaust pipe (not depicted). The exhaust gas 20 from the engine is sent to the first exhaust pipe 22. The first exhaust pipe 22 has a first large diameter part 30 connected to an upstream exhaust pipe (not depicted), a first tapered part 32 extending from the first large diameter part 30 and narrowing in diameter moving downstream in the flow direction of the exhaust gas 20, and a first small diameter part 34 extending from the first tapered part 32 downstream in the flow direction.

The exhaust gas 20 that has passed through the first exhaust pipe 22 is supplied to the second exhaust pipe 24. The downstream end part of the first exhaust pipe 22 is inserted into the second exhaust pipe 24, and an annular flow path 46 is formed between the second exhaust pipe 24 and the outer periphery of the first exhaust pipe 22 as a gap through which the exhaust gas 20 can flow. The second exhaust pipe 24 has a second large diameter part 40 at the upstream end part, provided so as to surround the first small diameter part 34 at the downstream end part of the first exhaust pipe 22. The second exhaust pipe 24 also has a second tapered part 42 that extends from the second large diameter part 40 and narrows in diameter while moving downstream in the flow direction, and a second small diameter part 44 that extends from the second tapered part 42 downstream in the flow direction.

The inner diameter dimension of the second large diameter part 40 of the second exhaust pipe 24 is larger than the outer diameter dimension of the first small diameter part 34 of the first exhaust pipe 22. As a result, an annular flow path 46 is formed between the outer periphery of the first small diameter part 34 of the first exhaust pipe 22 and the inner periphery of the second large diameter part 40 of the second exhaust pipe 24.

A weld part 44a of the second small diameter part 44, which is to be welded to a bearing member 163 (described later), is formed to be flat, and the other portion of the second small diameter part 44 is formed cylindrical. As a result, the flow path cross-section on the inner periphery of the second small diameter part 44 is formed into a substantially D-shape by the flat weld part 44a and the other cylindrical portions. A valve 161 (described later) that switches the flow of the exhaust gas 20 flowing through the second exhaust pipe 24 is provided in the second small diameter part 44 of the second exhaust pipe 24.

The third exhaust pipe 26 is provided so as to surround the downstream end part of the first exhaust pipe 22 and the second exhaust pipe 24. Specifically, the third exhaust pipe 26 surrounds the outer periphery of the first exhaust pipe 22 from a downstream portion of the first large diameter part 30 to the first small diameter part 34, and the entire second exhaust pipe 24. The third exhaust pipe 26 has a third large diameter part 60 provided on the outer periphery of the second exhaust pipe 24, a third tapered part 62 extending from the third large diameter part 60 and narrowing in diameter toward downstream in the flow direction, and a third small diameter part 64 extending from the third tapered part 62 downstream in the flow direction. The upstream portion of the third large diameter part 60 in the flow direction is formed by a cylindrical member 66 which is a separate member.

The inner diameter dimension of the third large diameter part 60 of the third exhaust pipe 26 is larger than the outer diameter dimension of the second large diameter part 40 of the second exhaust pipe 24, and an annular gap is formed between the second large diameter part 40 of the second exhaust pipe 24 and the third large diameter part 60 of the third exhaust pipe 26. As a result, a bypass flow path 68 is formed around the outer peripheral part of the second large diameter part 40 of the second exhaust pipe 24, through which flows the exhaust gas 20 that has passed through the annular flow path 46.

The third exhaust pipe 26 has a flange part 61 that protrudes radially outward from the outer periphery of the third large diameter part 60 of the third exhaust pipe 26. The flange part 61 is provided on the outer periphery of a hole that penetrates the third exhaust pipe 26 in the radial direction and into which a bearing member 163 (described later) is inserted. The flange part 61 is formed in a substantially cylindrical shape having an inner circumferential surface that abuts against the outer circumferential surface of the bearing member 163.

A collar 70 is provided around the entire circumference between the end part of the third large diameter part 60 of the third exhaust pipe 26 and the first large diameter part 30 of the first exhaust pipe 22.

The collar 70 has an inner circumferential wall 72 and an outer circumferential wall 74, and is formed to have a generally U-shaped cross-section. The collar 70 is attached to the first large diameter part 30 of the first exhaust pipe 22 with the inner circumferential wall 72 in close contact with the first large diameter part 30. Furthermore, the collar 70 is attached to the third large diameter part 60 of the third exhaust pipe 26 with the outer circumferential wall 74 in close contact with the third large diameter part 60. As a result, the end part of the bypass flow path 68 is closed by the collar 70.

An annular heat recovery material 80 is provided between the second large diameter part 40 of the second exhaust pipe 24 and the third large diameter part 60 of the third exhaust pipe 26, through which the exhaust gas 20 passes and which exchanges heat with cooling water as a medium flowing through a medium flow path 132, described later, which is provided on the outer periphery of the third exhaust pipe 26. The heat recovery material 80 is formed in an annular shape surrounding the second exhaust pipe 24 and recovers heat from the exhaust gas 20 flowing through the bypass flow path 68.

The heat recovery material 80 is made of a material containing ceramic as a main component, for example. The thermal expansion coefficient of the heat recovery material 80, which is mainly composed of ceramic, is different from the thermal expansion coefficient of each of the exhaust pipes 22, 24, 26, which are made of metal. The heat recovery material 80 is made of a honeycomb structure. Specifically, the heat recovery material 80 includes a cylindrical inner tubular part 84 that forms an inner circumferential surface, a cylindrical outer tubular part 88 that forms an outer circumferential surface, and a honeycomb part 90 that is provided between the inner tubular part 84 and the outer tubular part 88.

The honeycomb part 90 is made up of a honeycomb-shaped core material. Vertical and horizontal walls that make up the honeycomb part 90 extend in the flow direction of the exhaust gas 20 that flows through the bypass flow path 68. As a result, the honeycomb part 90 has a plurality of flow paths penetrating in the flow direction, and recovers heat from the exhaust gas 20 passing through each flow path while allowing the exhaust gas 20 to flow.

A gasket 100 serving as a pressing member is provided between the heat recovery material 80 and the second large diameter part 40 of the second exhaust pipe 24.

The gasket 100 is formed of a cylindrical plate-like member. The plate-like member that constitutes the gasket 100 is made of, for example, a metal plate. The gasket 100 is formed to a size that allows the gasket to be fitted onto the second large diameter part 40 of the second exhaust pipe 24.

The gasket 100 is provided between the second exhaust pipe 24 and the heat recovery material 80, and presses both together in a radial direction. Specifically, the gasket 100 is fitted onto the inner circumferential surface of the inner tubular part 84 of the heat recovery material 80 in a reduced diameter state, and then attached by expanding the second large diameter part 40 of the second exhaust pipe 24. As a result, the gasket 100 is provided in a state of being inserted between the second large diameter part 40 of the second exhaust pipe 24 and the heat recovery material 80.

The gasket 100 is capable of elastic deformation in the radial direction when provided between the second large diameter part 40 of the second exhaust pipe 24 and the heat recovery material 80. In the attached state, the gasket 100 presses the heat recovery material 80 such that the outer circumferential surface of the outer tubular part 88 is in close contact with the inner circumferential surface of the third exhaust pipe 26. The heat recovered by the heat recovery material 80 is transferred to the cylindrical member 66 that constitutes the third large diameter part 60 of the third exhaust pipe 26.

The gasket 100 is provided so as to be slidable relative to the second exhaust pipe 24 in the longitudinal direction of the second exhaust pipe 24 (the direction along the center axis 28). As a result, the gasket 100 allows relative thermal deformation between the second exhaust pipe 24 and the heat recovery material 80 in the longitudinal direction of the second exhaust pipe 24. The specific operation will be described in detail in the description of operations and effects.

The heat recovery part 14 uses the heat of the exhaust gas 20 to heat the cooling water. The heat recovery part 14 includes a tubular member 130, a supply pipe 140, and a recovery pipe 142.

The tubular member 130 is provided on the outer peripheral part of the cylindrical member 66 that constitutes the third large diameter part 60 of the third exhaust pipe 26 so as to surround the cylindrical member 66 over the entire circumference. The tubular member 130 includes a container-shaped member main body 134 that protrudes outward and forms a medium flow path 132 between member main body and the cylindrical member 66, and a pair of retaining flanges 136 that extend from an edge part of the member main body 134. The tubular member 130 is attached by the retaining flanges 136 in close contact with the cylindrical member 66. The supply pipe 140 and the recovery pipe 142 (see FIG. 1) are connected to the member main body 134.

The supply pipe 140 supplies cooling water to the medium flow path 132. The recovery pipe 142 recovers the cooling water in the medium flow path 132. The supply pipe 140 and the recovery pipe 142 are arranged at positions mutually separated in the circumferential direction of the member main body 134.

The heat of the exhaust gas 20 recovered by the heat recovery material 80 is transferred to the cooling water flowing through the medium flow path 132 via the cylindrical member 66 of the third exhaust pipe 26. Thereby, a heat recovery part 14 is formed that uses the heat of the exhaust gas 20 to heat the cooling water.

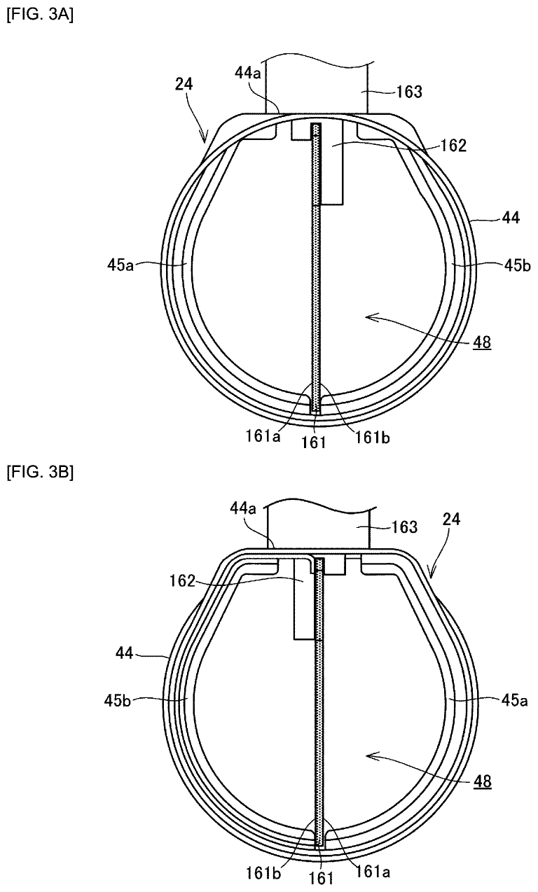

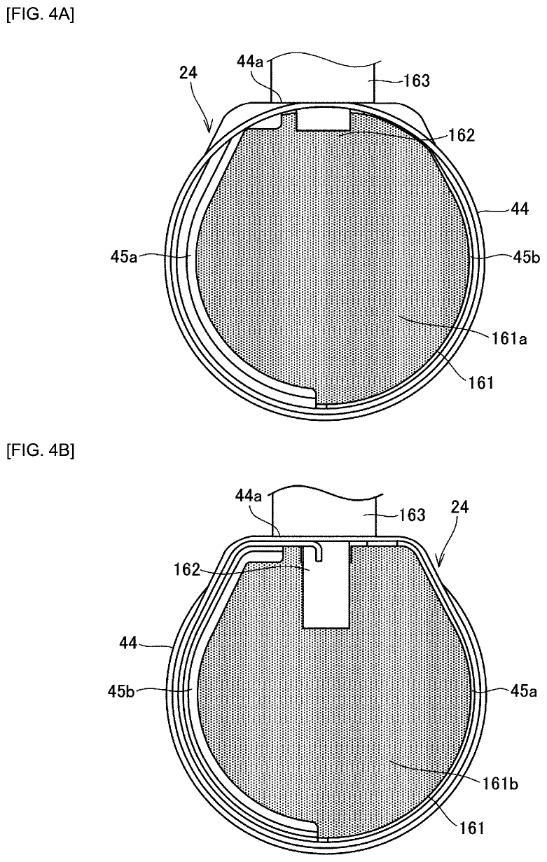

Next, the switching mechanism part 16 will be described with reference to FIGS. 3A to 4B. FIG. 3A is a left side view of the vicinity of the valve 161 in FIG. 2, depicting the valve 161 in an open state. FIG. 3B is a right side view of the vicinity of the valve 161 in FIG. 2, depicting the valve 161 in an open state. FIG. 4A is a left side view of the vicinity of the valve 161 in FIG. 2, depicting the valve 161 in a closed state. FIG. 4B is a right side view of the vicinity of the valve 161 in FIG. 2, depicting the valve 161 in a closed state. Note that in FIG. 3A to FIG. 4B, the valve 161 is depicted by hatching to make the state of the valve 161 easier to understand.

As depicted in FIG. 2, the switching mechanism part 16 includes a valve 161, a spindle 162 as a rotating shaft, a bearing member 163 for the valve 161, a seal member 164, an actuator 169, and a retaining member 170. The switching mechanism part 16 switches the flow of the exhaust gas 20 in the gas flow path part 12.

As depicted in FIG. 3A and FIG. 3B, the valve 161 is formed in the shape of a flat plate having a front surface 161a and a rear surface 161b. The valve 161 is formed in a shape corresponding to the flow path cross-section of the second small diameter part 44 of the second exhaust pipe 24. In other words, the valve 161 is formed in a substantially D-shape corresponding to the substantially D-shaped flow path cross-section of the second small diameter part 44 (see FIG. 4A and FIG. 4B). The valve 161 is rotatably supported by the spindle 162. The valve 161 opens and closes a connecting passage 48 that connects the second exhaust pipe 24 to the third exhaust pipe 26 without passing through the annular flow path 46, downstream of the portion of the second exhaust pipe 24 where the first exhaust pipe 22 is inserted.

When the valve 161 is in an open state (the state depicted in FIG. 3A and FIG. 3B) in which the front surface 161a and the rear surface 161b are provided along the flow direction, the exhaust gas 20 from the first exhaust pipe 22 flows downstream of the second exhaust pipe 24. When the valve 161 is in a closed state (the state depicted in FIG. 4A and FIG. 4B) in which the front surface 161a faces upstream in the flow direction and the rear surface 161b faces downstream in the flow direction, the flow of exhaust gas 20 is suppressed downstream of the second exhaust pipe 24 and the flow of exhaust gas 20 is promoted toward the annular flow path 46.

In other words, when the connecting passage 48 is closed, the valve 161 allows the exhaust gas 20 to flow through the annular flow path 46 and be guided to the heat recovery material 80, and when the connecting passage 48 is open, the valve 161 allows the exhaust gas 20 to flow so as to bypass the heat recovery material 80. Note that switching the flow of exhaust gas 20 will be described in detail in the description of the operations and effects.

As depicted in FIG. 3A and FIG. 3B, arc-shaped stoppers 45a and 45b are provided on the inner periphery of the second small diameter part 44 of the second exhaust pipe 24. The stopper 45a is provided so as to protrude into the connecting passage 48 over approximately half of the inner periphery of the second small diameter part 44. The stopper 45b is provided so as to protrude into the connecting passage 48 over the remaining approximately half of the inner periphery of the second small diameter part 44 where the stopper 45a is not provided. The stopper 45a and the stopper 45b face each other with the valve 161 interposed therebetween. The stopper 45b is provided at a position separated by the thickness of the valve 161 on the downstream side of the stopper 45b in the flow direction of the exhaust gas 20 (the direction along the center axis 28).

As depicted in FIG. 4A and FIG. 4B, when the valve 161 is switched from an open state to a closed state, the front surface 161a of the valve 161 abuts against the downstream surface of one stopper 45a in the flow direction, and the rear surface 161b of the valve 161 abuts against the upstream surface of the other stopper 45b in the flow direction. Thereby, the amount of exhaust gas 20 that flows out from the connecting passage 48 when the valve 161 is closed can be suppressed.

As depicted in FIG. 2, the spindle 162 is formed in a substantially cylindrical shape. The spindle 162 is provided to penetrate from the outside of the third exhaust pipe 26 to the inside of the second exhaust pipe 24. A valve 161 is provided at a first end of the spindle 162. A second end of the spindle 162 is attached to an actuator 169. The rotation of the spindle 162 is controlled by the actuator 169. The spindle 162 has a tapered part 162a that is formed such that the diameter decreases from the first end to the second end. The first end of the spindle 162 has a larger diameter than the second end.

The bearing member 163 is formed in a tubular shape (here, substantially cylindrical). The bearing member 163 is provided between the second exhaust pipe 24 and the third exhaust pipe 26, and extends so as to penetrate through the third exhaust pipe 26 to the outside. The bearing member 163 connects and retains the second exhaust pipe 24 and the third exhaust pipe 26. The bearing member 163 has a seal member 164 that seals between the spindle 162 of the valve 161 and the second exhaust pipe 24.

The bearing member 163 has a recessed part 163a, a first welded part 163c, a second welded part 163d, and a sliding part 163e. The bearing member 163 is formed from a metal that can be welded to the second exhaust pipe 24 and the third exhaust pipe 26. The bearing member 163 is made of, for example, stainless steel.

The recessed part 163a is formed in a recessed shape in the center axis direction from the end part of the bearing member 163 on the second exhaust pipe 24 side. The recessed part 163a is formed to have a larger diameter than the sliding part 163e. A seal member 164 is provided in the recessed part 163a.

The first welded part 163c retains and seals the end surface of the bearing member 163 and the second exhaust pipe 24 by welding. Specifically, the first welded part 163c is formed by welding a flat weld part 44a on the second small diameter part 44 of the second exhaust pipe 24 to the end surface of the bearing member 163.

At this time, the weld part 44a is formed to be flat, and therefore comes into surface contact with the annular end surface of the bearing member 163, which is also formed to be flat. Therefore, the bearing member 163 and the second exhaust pipe 24 can be easily welded together, and the quality of the first welded part 163c can be stabilized.

The second welded part 163d retains and seals the outer circumferential surface of the bearing member 163 and the third exhaust pipe 26 by welding. Specifically, the second welded part 163d is formed by welding the inner circumferential surface of the flange part 61 that protrudes from the third large diameter part 60 of the third exhaust pipe 26 toward the outer periphery and the outer circumferential surface of the bearing member 163 together.

At this time, the flange part 61 is provided on the third exhaust pipe 26, so the contact area (contact length) between the flange part 61 and the outer circumferential surface of the bearing member 163 can be increased. Therefore, the bearing member 163 and the third exhaust pipe 26 can be easily welded together, and the quality of the second welded part 163d can be stabilized.

The sliding part 163e is a circular hole in which the outer circumferential surface of the spindle 162 slides. The sliding part 163e is formed along the center axis direction of the bearing member 163. The sliding part 163e is formed to have approximately the same diameter as the outer diameter of the spindle 162.

The seal member 164 is provided in the recessed part 163a of the bearing member 163. The seal member 164 is provided in a compressed state between the bottom surface of the recessed part 163a and the tapered part 162a of the spindle 162. The seal member 164 seals the spindle 162 and the end part of the sliding part 163e of the spindle 162.

The actuator 169 is driven by power supplied from a power supply unit (not depicted). The actuator 169 is controlled by an electrical signal from a controller (not depicted). The actuator 169 drives the spindle 162 to rotate.

The retaining member 170 is a cup-shaped metal member that supports the actuator 169. The retaining member 170 is attached to the third exhaust pipe 26 and the outer surface of the tubular member 130 at a plurality of locations using a plurality of brackets 171 (see FIG. 1).

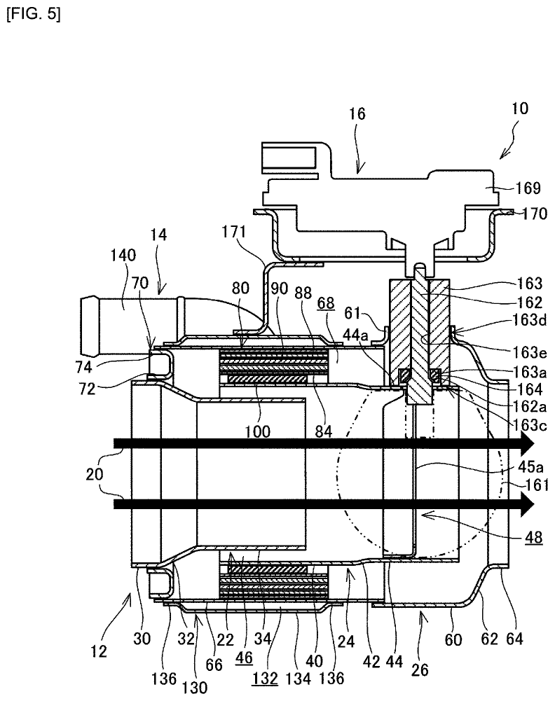

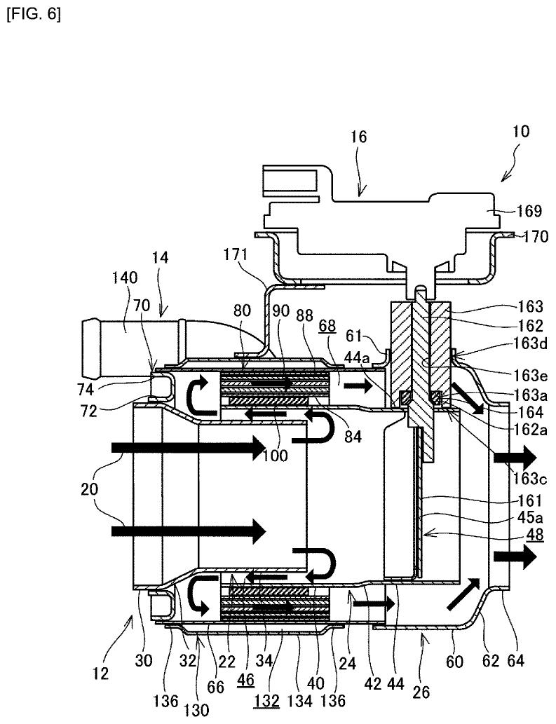

Next, the operation of the exhaust heat recovery device 10 will be described with reference to FIG. 5 and FIG. 6. FIG. 5 is a cross-sectional view of the exhaust heat recovery device 10 for describing the flow of the exhaust gas 20, when the valve 161 is in an open state. FIG. 6 is a cross-sectional view of the exhaust heat recovery device 10 for describing the flow of the exhaust gas 20 when the valve 161 is in a closed state.

First, with reference to FIG. 5, a case where the valve 161 is in an open state and the heat of the exhaust gas 20 is not recovered by the cooling water flowing through the heat recovery part 14 will be described.

As depicted in FIG. 5, the exhaust gas 20 emitted from the engine flows into the first exhaust pipe 22 via an upstream exhaust pipe (not depicted). The exhaust gas 20 that flows into the exhaust heat recovery device 10 from the first exhaust pipe 22 travels straight ahead and is guided into the second exhaust pipe 24.

At this time, the valve 161 is in an open state and the connecting passage 48 is open, so the exhaust gas 20 that flows into the second exhaust pipe 24 passes through the connecting passage 48 and is guided into the third exhaust pipe 26, and then flows out into a downstream exhaust pipe (not depicted). In other words, the exhaust gas 20 flows through the exhaust heat recovery device 10 so as to bypass the heat recovery material 80.

Therefore, the exhaust gas 20 is not guided to the heat recovery material 80, and the heat of the exhaust gas 20 is not recovered by the cooling water flowing through the heat recovery part 14.

From this state, when the actuator 169 rotates the spindle 162 to close the valve 161, the state depicted in FIG. 6 is achieved.

Next, a case where the valve 161 is in a closed state and the heat of the exhaust gas 20 is recovered by the cooling water flowing through the heat recovery part 14 will be described, with reference to FIG. 6.

As depicted in FIG. 6, the exhaust gas 20 emitted from the engine flows into the first exhaust pipe 22 via an upstream exhaust pipe (not depicted). The exhaust gas 20 that flows into the exhaust heat recovery device 10 from the first exhaust pipe 22 travels straight ahead and is guided into the second exhaust pipe 24. At this time, the valve 161 is in a closed state and the connecting passage 48 is closed, so the exhaust gas 20 that has flowed into the second exhaust pipe 24 passes through the annular flow path 46 and is guided to the bypass flow path 68. The exhaust gas 20 guided to the bypass flow path 68 passes through the heat recovery material 80, and heat is transferred to the cooling water flowing through the heat recovery part 14. The exhaust gas 20 is then guided from the bypass flow path 68 into the third exhaust pipe 26 and flows out into a downstream exhaust pipe (not depicted).

Therefore, the exhaust gas 20 is guided to the heat recovery material 80, and the heat of the exhaust gas 20 is recovered by the cooling water flowing through the heat recovery part 14.

At this time, the bearing member 163 provided between the second exhaust pipe 24 and the third exhaust pipe 26 is attached and sealed to the second exhaust pipe 24 by the first welded part 163c, and is attached and sealed to the third exhaust pipe 26 by the second welded part 163d. In other words, the bearing member 163 connects and retains the second exhaust pipe 24 and the third exhaust pipe 26, and also seals the gap between the spindle 162 of the valve 161 and the second exhaust pipe 24. Therefore, when the valve 161 is closed, the exhaust gas 20 can be prevented from flowing out from between the spindle 162 of the valve 161 and the second exhaust pipe 24.

Furthermore, the bearing member 163 is also provided with a seal member 164 that seals the gap between the spindle 162 and the end part of the sliding part 163e in the recessed part 163a. Therefore, the exhaust gas 20 flowing out from the gap on the outer periphery of the spindle 162 can be prevented from being guided to the bypass flow path 68 or the outside of the third exhaust pipe 26.

Therefore, almost all of the exhaust gas 20 flowing in from the upstream exhaust pipe (not depicted) is guided to the heat recovery material 80, thereby improving the performance of recovering heat from the exhaust gas 20 in the exhaust heat recovery device 10.

A gasket 100 is provided to press the second exhaust pipe 24 and the heat recovery material 80 together in the radial direction. The gasket 100 allows relative thermal deformation between the second exhaust pipe 24 and the heat recovery material 80 in the longitudinal direction of the second exhaust pipe 24.

Here, the bearing member 163 is connected and retained to the second exhaust pipe 24 and the third exhaust pipe 26 by the first welded part 163c and the second welded part 163d. In other words, the second exhaust pipe 24 is supported by the third exhaust pipe 26 via the bearing member 163, and the position is constrained. On the other hand, the heat recovery material 80 is fitted into the third exhaust pipe 26 (cylindrical member 66) and the position is constrained. Furthermore, the heat recovery material 80 is mainly composed of ceramic, and has a different coefficient of thermal expansion than the metal exhaust pipes 22, 24, 26, so when both are subjected to heat, a difference in thermal expansion occurs. With such a structure, the space between the second exhaust pipe 24 and the heat recovery material 80 must be sealed to prevent bypassing by the exhaust gas 20, but if both are constrained by the sealing structure, stress will be generated due to the difference in thermal expansion. In other words, if the second exhaust pipe 24 is constrained at the first end by the bearing member 163 and at the second end part by the heat recovery material 80, stress will be generated in the second exhaust pipe 24.

In contrast, in the exhaust heat recovery device 10, the gasket 100 is provided so as to be slidable relative to the second exhaust pipe 24 in the longitudinal direction of the second exhaust pipe 24 (the direction along the center axis 28). In other words, the gasket 100 allows relative thermal deformation between the second exhaust pipe 24 and the heat recovery material 80 in the longitudinal direction of the second exhaust pipe 24. Therefore, even if the second exhaust pipe 24 is heated by the exhaust gas 20 and thermally deforms starting from the position that is welded to the bearing member 163, the gasket 100 slides relative to the second exhaust pipe 24, so the force caused by thermal deformation is not transmitted to the heat recovery material 80. Therefore, durability against thermal fatigue can be improved, as compared to a case where the heat recovery material 80 is attached to the second exhaust pipe 24 and the third exhaust pipe 26 by brazing or the like.

In addition, if the external dimensions of the second exhaust pipe 24 increase due to the heat of the exhaust gas 20, the gasket 100 will elastically deform, so misalignment of the heat recovery material 80 caused by thermal expansion of the second exhaust pipe 24 can be suppressed. In particular, the heat recovery material 80 can be prevented from shifting out of position even when applied to a hybrid vehicle that switches between engine drive and motor drive, and the temperature change in the exhaust heat recovery device 10 is large.

The following effects are achieved by the aforementioned embodiment.

The exhaust heat recovery device 10 contains: a first exhaust pipe 22; a second exhaust pipe 24 into which a downstream end part of the first exhaust pipe 22 is inserted, forming an annular flow path 46 between the second exhaust pipe and an outer periphery of the first exhaust pipe 22, through which exhaust gas 20 can flow; a third exhaust pipe 26 provided so as to surround the downstream end part of the first exhaust pipe 22 and the second exhaust pipe 24; an annular heat recovery material 80 that is provided between the second exhaust pipe 24 and the third exhaust pipe 26, through which the exhaust gas 20 passes inside, and that performs heat exchange with a medium flow path 132 provided on an outer periphery of the third exhaust pipe 26; a valve 161 that opens and closes the second exhaust pipe 24, located downstream of the portion of the second exhaust pipe 24 into which the first exhaust pipe 22 is inserted; and a bearing member 163 for the valve 161 provided between the second exhaust pipe 24 and the third exhaust pipe 26; wherein when the valve 161 is closed, the exhaust gas 20 passes through the annular flow path 46 and is guided to the heat recovery material 80, and when the valve 161 is open, the exhaust gas 20 bypasses the heat recovery material 80 and is guided to the third exhaust pipe 26; and the bearing member 163 connects to and retains the second exhaust pipe 24 and the third exhaust pipe 26, and seals between the spindle 162 of the valve 161 and the second exhaust pipe 24.

With this configuration, the bearing member 163 provided between the second exhaust pipe 24 and the third exhaust pipe 26 connects and retains the second exhaust pipe 24 to the third exhaust pipe 26, and seals the gap between the spindle 162 of the valve 161 and the second exhaust pipe 24. Therefore, when the valve 161 is closed, the exhaust gas 20 can be prevented from flowing out from between the spindle 162 of the valve 161 and the second exhaust pipe 24. Therefore, the heat recovery performance from the exhaust gas 20 in the exhaust heat recovery device 10 can be improved.

Embodiments of the present invention have been described above, so the above-mentioned embodiments merely depict some of the application examples of the present invention, and are not intended to restrict the technical scope of the present invention to the specific configurations of the above-mentioned embodiments.

For example, the exhaust heat recovery device 10 according to the above embodiment has been described as warming the cooling water with recovered heat, but the embodiments are not limited to this case. For example, the exhaust heat recovery device 10 may use the recovered heat to warm gear oil or the like.

Furthermore, in the above embodiment, the exhaust heat recovery device 10 is described as being applied to an automobile, but the above embodiment is not limited to this case, and the exhaust heat recovery device 10 may be applied to something other than a vehicle.

This application claims priority based on Japanese Patent Application No. 2023-082327, filed with the Japan Patent Office on May 18, 2023. The entire contents of these applications are incorporated herein by reference.

1. An exhaust heat recovery device, comprising:
a first exhaust pipe;
a second exhaust pipe into which a downstream end part of the first exhaust pipe is inserted, forming a gap between the second exhaust pipe and an outer periphery of the first exhaust pipe, through which exhaust gas can flow;
a third exhaust pipe provided so as to surround the downstream end part of the first exhaust pipe and the second exhaust pipe;
an annular heat recovery material that is provided between the second exhaust pipe and the third exhaust pipe, through which the exhaust gas passes inside, and that performs heat exchange with a medium flow path provided on an outer periphery of the third exhaust pipe;
a valve that opens and closes the second exhaust pipe, located downstream of the portion of the second exhaust pipe into which the first exhaust pipe is inserted; and
a bearing member for the valve provided between the second exhaust pipe and the third exhaust pipe;
wherein
when the valve is closed, the exhaust gas passes through the gap and is guided to the heat recovery material, and when the valve is open, the exhaust gas bypasses the heat recovery material and is guided to the third exhaust pipe; and
the bearing member connects to and retains the second exhaust pipe and the third exhaust pipe, and seals between the rotary shaft of the valve and the second exhaust pipe.

2. The exhaust heat recovery device according to claim 1, further comprising:
a pressing member provided between the second exhaust pipe and the heat recovery material to press the second exhaust pipe and the heat recovery material against each other in a radial direction; wherein
the pressing member allows relative thermal deformation between the second exhaust pipe and the heat recovery material in the longitudinal direction of the second exhaust pipe.

3. The exhaust heat recovery device according to claim wherein
the bearing member is tubular and has a sliding part on which the outer circumferential surface of the rotating shaft slides,
and further contains:
a first welded part that retains and seals the end surface of the bearing member and the second exhaust pipe by welding;
a second welded part that retains and seals an outer circumferential surface of the bearing member and the third exhaust pipe by welding; and
a seal member that seals the rotary shaft and an end part of the sliding part within the bearing member.

4. The exhaust heat recovery device according to claim 1, wherein
the second exhaust pipe further includes a first welded part welded to the bearing member;
the first weld is formed to be flat; and
the valve has a shape corresponding to the flow path cross-section of the second exhaust pipe.

5. The exhaust heat recovery device according to claim 1, wherein the bearing member is made of stainless steel.
